(19) United States
(12) Patent Application Publication
(10) Pub. No.: US 2023/0209439 A1
(43) Pub. Date: Jun. 29, 2023

(54) ROUTE DISCOVERY IN A MESH NETWORK

(71) Applicant: MediaTek Singapore Pte. Ltd., Singapore (SG)

(72) Inventors: Nathan Edward TENNY, San Jose, CA (US); Xuelong WANG, Beijing (CN)

(73) Assignee: MediaTek Singapore Pte. Ltd., Singapore (SG)

(21) Appl. No.: 18/090,615

(22) Filed: Dec. 29, 2022

(30) Foreign Application Priority Data
Dec. 29, 2021 (WO) PCT/CN2021/142595
Dec. 13, 2022 (CN) 202211603273.6

(51) Int. Cl. H04W 40/24

(52) U.S. Cl. CPC H04W 40/248; H04W 40/246; H04W 84/18

(57) ABSTRACT

An apparatus operated as a relay node in a wireless mesh network for route discovery comprises processing circuitry that receives, from a first neighbor node, a discovery request including a request for a route to a destination node. When the routing table of the first node contains routes to the destination node, the first node sends, to the first neighbor node, a discovery response including information about these routes. When the routing table of the first node does not contain a route to the destination node, the first node sends, to a second neighbor node, a discovery request for a route to the destination node. When the first node receives, from the second neighbor node, a discovery message including information of routes to a destination node. The first node transmits, to the first neighbor node, a discovery response including information of these routes.

### INCORPORATION BY REFERENCE

This present disclosure claims the benefit of China Application No. 202211603273.6, filed on Dec. 13, 2022, which claims the benefit of International Application No. PCT/CN2021/142595, filed on Dec. 29, 2021. The entire disclosures of the prior applications are hereby incorporated by reference in their entirety.

### TECHNICAL FIELD

The present disclosure relates to wireless communications, and specifically to a procedure for establishing routes between nodes in a mesh network.

### BACKGROUND

In 4G and 5G communication networks, sidelink communication allows data packets to be transmitted through the neighboring devices without relaying through the base station. In the existing art, sidelink communication takes place either directly from a source device to a destination device, or through a single relay device, so that a packet can always be delivered to its destination with no ambiguity of routing. However, if sidelink communication is extended to support multi-hop relay or mesh topologies, a routing algorithm becomes necessary to ensure that data packets can be delivered correctly and efficiently to the destination node.

### SUMMARY

Aspects of the disclosure provide a method of route discovery in a mesh network. Under this method, a first node W in the mesh network receives, from a neighbor node X, a discovery request message including a request for a route to a destination node Z. It is determined whether the routing table of the first node contains one or more routes to the destination node. When the routing table of the first node contains one or more routes to the destination node Z, the first node sends, to the node X, a discovery response message including information about the one or more routes. When the routing table of the first node does not contain one or more routes to the destination node Z, the first node W sends, to another neighbor node Y, a discovery request message including a request for a route to the destination node Z.

In an embodiment, each node involved (W, X, Y, and Z) may be a user equipment (UE) or a base station (eNB and/or gNB). In an embodiment, logical connections are established between the first node W and its neighbors, X, Y, and Z. These logical connections could be one of PC5 unicast links, a radio resource control (RRC) connection, and PR5-RPC connections. In an embodiment, the discovery request messages are PC5-S protocol messages.

In an embodiment, the discovery request messages are sent by unicast (to the recipient node only), or by broadcast (to any node that can receive it), or by groupcast (to an identified set of nodes including the recipient node). In an embodiment, the information of routes to the destination node includes a hop count limit, a quality measurement of the transmission via the route path, or a list of intermediate nodes in the route path. In an embodiment, the discovery request messages contain a sequence number as a unique identifier.

In an embodiment, the discovery request messages contain a maximum hop count. It is determined, by a node that may transmit a discovery request message, whether the hop count of a discovery response would exceed the maximum hop count. If the hop count of a discovery response message exceeds the maximum hop count, the discovery request message would not be sent.

In an embodiment, the first node W receives, from the neighbor node Y, a discovery response message including information of one or more routes to the destination node Z. The first node W updates its routing table by adding the one or more routes. Then the first node W transmits, to the neighbor node X, a discovery response message including information of the one or more routes to the destination node Z. In an embodiment, the discovery response messages are PC5-S protocol messages. In an embodiment, the discovery request messages are sent by unicast, or by broadcast, or by groupcast.

In an embodiment, the discovery request messages contain one or more criteria, the discovery response message from the neighbor node Y contains a plurality of routes, and the discovery response to the neighbor node X omits one or more routes from the discovery response message from the neighbor node Y if these routes fail to meet these criteria. In an embodiment, the one or more criteria include a maximum hop count and/or a minimum route quality threshold. In an embodiment, each discovery response message contains a sequence number which is the same as the sequence number of its corresponding discovery request message.

In an embodiment, a method of discovery in a first node A is provided. The first node A has a radio connection to a second node B. The first node transmits, to a neighbor node C, a discovery announcement including the information that the first node has a radio connection to the second node B, wherein the second node B is a node of a cellular network. In an embodiment, the discovery announcement includes information about the link quality of the radio connection to the second node.

Aspects of the disclosure provide an apparatus operated as a mesh node in a wireless mesh network for route discovery. The apparatus includes processing circuitry configured to receive, from a neighbor node X, a discovery request message including a request for a route to a destination node Z. It is determined whether the routing table of the first node contains one or more routes to the destination node. If the routing table of the first node contains one or more routes to the destination node Z, the first node sends, to the node X, a discovery response message including information about the one or more routes. If the routing table of the first node does not contain one or more routes to the destination node Z, the first node W sends, to another neighbor node Y, a discovery request message including a request for a route to the destination node Z.

In an embodiment, the apparatus receives, from the neighbor node Y, a discovery response message including information of one or more routes to the destination node Z. The first node W updates its routing table by adding the one or more routes. Then the first node W transmits, to the neighbor node X, a discovery response message including information of the one or more routes to the destination node Z.

Aspects of the disclosure provide a non-transitory computer-readable storage medium storing a program implementing any one or a combination of methods for route discovery in a mesh network.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an example of a delivery of a packet in a mesh network of user equipments (UEs) according to embodiments of the disclosure;

FIG. 2 shows an example of a mesh network in which a distinguished UE can operate as a gateway to a network node according to embodiments of the disclosure;

FIG. 3 shows an example of a discovery procedure in which an announcing node informs a monitoring node that the announcing node has a connection to the network according to embodiments of the disclosure;

FIG. 4 shows an example of a discovery procedure in which a discoverer node requests from a discovered node a route to a destination node according to embodiments of the disclosure;

FIG. 5 shows an example of a discovery procedure in a mesh network comprising the maintenance of routing tables at a plurality of nodes and the delivery of a packet according to embodiments of the disclosure;

FIG. 6 shows an example of a user-plane protocol stack for a layer 2 mesh network according to embodiments of the disclosure;

FIG. 7 shows an example of a discovery protocol stack for a mesh network according to embodiments of the disclosure;

FIG. 8 shows an example of a mesh network topology according to embodiments of the disclosure;

FIG. 9 shows an example of a discovery procedure in a mesh network where a distinguished node has a link to a cellular network according to embodiments of the disclosure;

FIG. 10A-10B shows an example of a discovery procedure in a mesh network where a source node is provided with a plurality of routes to a cellular network according to embodiments of the disclosure;

FIG. 11 shows an example of a discovery procedure in a mesh network where a source node is provided with at least one route to a destination node according to embodiments of the disclosure.

FIG. 12 shows a flowchart outlining an exemplary process according to embodiments of the disclosure; and

FIG. 13 shows an example of an apparatus according to embodiments of the disclosure.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing an understanding of various concepts. However, these concepts may be practiced without these specific details.

Several aspects of telecommunication systems will now be presented with reference to various apparatuses and methods. These apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Direct device-to-device communication can be based on the Long Term Evolution (LTE) and New Radio (NR) “sidelink” technology. Two discovery models can be used for devices in proximity to discover one another's existence and interest in establishing communication. In Model A (also described as “I am here”), a first user equipment (UE), also described as an announcing UE, transmits an announcement. The announcement indicates that the announcing UE offers a particular service. A second UE, also described as a monitoring UE, receives the announcement. The second UE may determine to establish a connection for communication with the announcing node. In Model B (also described as “Who is there?”), a first UE, also described as a discoverer UE, transmits a solicitation. The solicitation indicates that the discoverer UE seeks a particular service. A second UE, also described as a discoveree UE, may transmit a response indicating that the discoveree UE offers the requested service.

In direct device-to-device communication, or in single-hop UE-to-network relaying (as supported for the NR sidelink in 3GPP Rel-17), UEs can discover other UEs with which they will communicate directly. In a multi-hop relaying scenario, devices communicate via a plurality of intermediary relay devices. In a mesh network, devices communicate as peers via packet forwarding through a path established among multiple peer devices. In these scenarios, a first device may have a prerequisite to discover a second device that is distant from the first device in terms of the mesh network topology. For example, a first UE W may seek communication with a second UE Z. The mesh network path from W to Z may pass through relay UEs X and Y. In such a situation, UEs W and Z may carry out a discovery procedure mediated by UEs X and Y. As a result of this discovery procedure, UEs W and Z can learn not only of each other's existence and availability to communicate, but also of the mesh network route connecting them. For example, UE W may determine that to deliver a packet to UE Z, UE W can first send the packet to UE X, with additional routing information indicating that the ultimate destination of the packet is UE Z.

All UEs operating in Model A and Model B have a built-in routing table that provide one or more next hops associated with the destination. the source node may determine the at least one first hop based on looking up the destination in the routing table. It is necessary for each UE to maintain its own routing table. When a UE receives new routing information of a specific destination from another node, the UE may update its routing table if the new routing information is absent in its routing table or is different from the existing routing information of the destination.

In various examples, when a discovery procedure is initiated, the discovery procedure may be one of discovering a node, discovering a service, and discovering a route. When a node is requested, only the requested node may send the initial response to the request in some examples. When a service is requested, all nodes that provide the service may respond the request in some examples. When a route is requested, the corresponding response includes all nodes and the order of these nodes in the path to the destination in some examples.

In some examples based on Rel-17 layer 2 UE-to-network relaying, a protocol layer, called Sidelink Relay Adaptation Protocol (SRAP), carries out certain routing and mapping functions. The functions include identifying the destination of a packet. A header format of the SRAP protocol may contain a field identifying the involved remote UE. In UE-to-network relaying, this field is used in the downlink direction to identify which remote UE should receive a packet from the network. A relay UE receives the packet from the network. The relay UE consults the SRAP header to determine which remote UE is the destination. The relay UE forwards the packet to the remote UE (while also applying additional functions such as bearer mapping). The existing SRAP behavior is not designed for a multi-hop or mesh environment. The SRAP protocol assumes that the relay UE has a unique connection directly to the destination remote UE. (In the uplink direction, the same or an analogous field of the SRAP header may identify which remote UE is the source of the packet. In some examples of single-hop UE-to-network relaying, the relay UE does not depend on this information for packet routing. In the uplink direction the relay UE always forwards packets to the network. The receiving network node relies on this field to distinguish which UE context the received packet may be associated with.)

In a mesh network, a plurality of nodes communicates as peers. A packet of data can potentially be handled by many peer devices on its way from a source device to a destination device. At each peer device, the “next hop” taken by the packet may be determined by consulting a routing table stored at the peer device. Various methods of determining a next hop from a routing table may be applied. For instance, a simple routing table may include a list of destinations. Each destination can have a single associated next hop. The peer device may perform routing by looking up a packet's destination in the routing table and passing the packet to the associated next hop. A more sophisticated routing table may contain additional information, such as multiple candidate next hops for a given destination, information about the complete path between the peer node and the destination, measures of link quality for the link to a next-hop candidate, and so on. This additional information may be used, for instance, to adapt to a changing network topology, to select a route with good link quality to the destination, and/or to prevent routing loops in which a packet revisits the same node repeatedly rather than progressing towards its destination.

Throughout this disclosure, we distinguish between a “mesh” or “mesh network” and “network” or “cellular network”. A mesh or mesh network may include a mixture of cellular network nodes and mobile devices. A “network” or “cellular network” can include the network nodes of a conventional cellular system, such as base stations, core network nodes, and so on. When the term “network” is used without qualification, it refers to a cellular network.

In an embodiment, a mesh network includes a set of nodes. Any of the set of nodes may potentially be mobile or stationary. The set of the nodes can be in communication using device-to-device links in such a way that a first node of the mesh can deliver a communication (for instance, a data packet) to a second node of the mesh, even though the first node and the second node may not be in direct radio contact with one another. The communication may be forwarded by one or more additional nodes of the mesh operating as relays between the first node and the second node. An example may be a set of devices operating according to 3GPP specifications. The set of devices can include a mix of UEs and base stations (such as eNBs, gNBs, and the like) and communicating on radio interfaces (for example, a sidelink or PC5 interface between pairs of UEs, a Uu interface between a UE and a base station, and so on). A packet may be generated by a first node, addressed to a second node, and delivered according to a routing protocol from the first node to the second node via one or more intervening relay nodes.

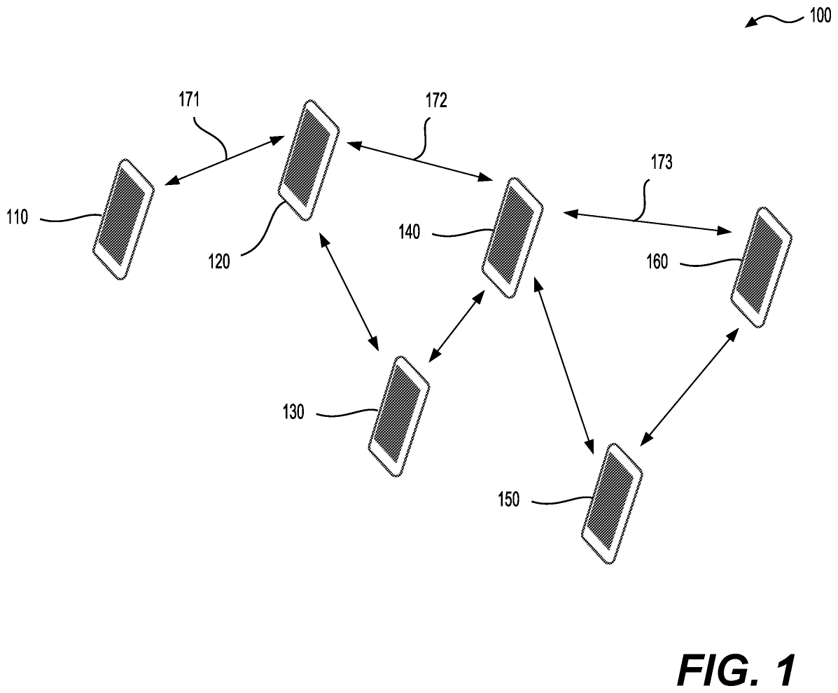

FIG. 1 shows an exemplary delivery of a packet in a mesh network 100 according to embodiments of the disclosure. In an embodiment of FIG. 1, all the mesh nodes are UEs, communicating with one another via a device-to-device interface (for example, a sidelink or PC5 interface). The mesh network 100 includes a collection of UEs 110-160, and a packet is delivered from UE 110 to UE 160. UE 110 generates a packet for transmission to UE 160, but there is no direct radio link between UE 110 and UE 160. In the absence of such a direct link, the packet can be delivered from UE 110 to UE 160 through multiple relay UEs. For example, UE 110 can transmit the packet to UE 120 (with which UE 110 has a direct link 171), which can transmit the packet to UE 140 (with which UE 120 has a direct link 172), which can transmit the packet to UE 160 (with which UE 140 has a direct link 173). Upon reception of the packet, UE 160 recognizes that it is the addressee of the communication (for instance, based on a destination identity in a header of the communication) and processes the packet.

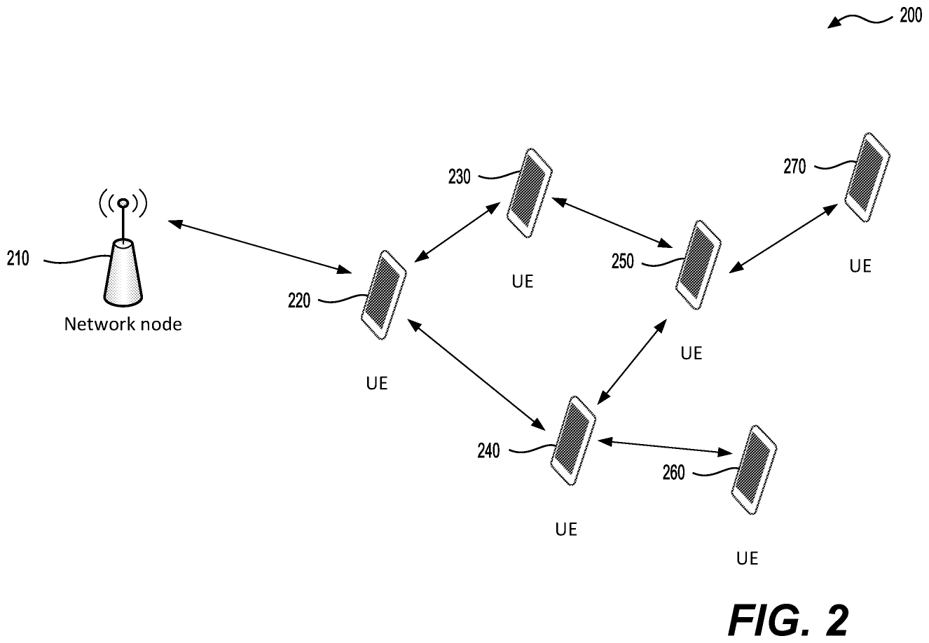

FIG. 2 shows an exemplary mesh network 200 in which a distinguished UE can operate as a gateway to a network node according to embodiments of the disclosure. In FIG. 2, a first node in the mesh network (such as UE 220) may maintain a direct connection to a network node 210 (for example, a base station). In such a case, the first node may act as a gateway to the cellular network for other nodes in the mesh. The first node, acting as an announcing node, may announce its ability to serve as a gateway with a first discovery message. The first discovery message is functionally similar to the discovery announcement in Model A in LTE or NR sidelink discovery but has the special semantics “I have a link to the network”. Adjacent UEs acting as monitoring nodes, such as UEs 230 and 240 in FIG. 2, may receive the discovery message and record the information that UE 220 has a connection to the network. This information may be recorded, for instance, in a routing table. In an embodiment, the information may be further propagated to other nodes in the mesh network. As an example, UE 230 may inform UE 250 that UE 220 has a link to the network. Subsequently, UE 250 may record the routing information involving UE 230 and/or UE 220 in its routing table. UE 250 may consider UE 220 as an intermediate node when UE 250 transmits packet to the network.

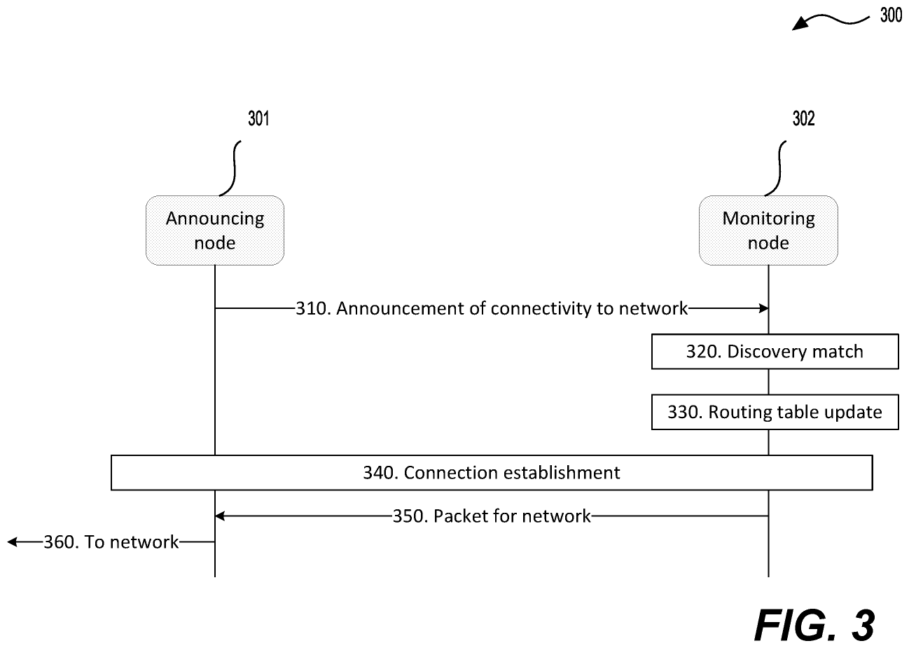

FIG. 3 shows an exemplary discovery procedure 300 in which an announcing node informs a monitoring node that the announcing node has a connection to the network (resembling the legacy discovery Model A) according to embodiments of the disclosure. In step 310, the announcing node 301 transmits a discovery announcement, indicating that the announcing node 310 has connectivity to a network (for instance, to a base station or a cell of an operator's cellular network). Within the discovery announcement, the identity of a base station or a cell may be included. In step 320, the monitoring node 302 performs a discovery match and determines that node 302 can communicate with the network via the announcing node 301. In step 330, the monitoring node 302 updates its routing table with information from the message in step 310, e.g., the information that the announcing node can be used as a next hop or an intermediate destination for transmission of packets towards the network. In step 340, the monitoring and announcing nodes establish a connection; this step may, for instance, use signaling of a PC5 signaling (PC5-S) protocol and/or a PC5 radio resource control (PC5-RRC) protocol. In step 350, the monitoring node 302 transmits a packet to the announcing node 301 for forwarding to the network. In step 360, the announcing node forwards the packet towards the network.

In a mesh network with a small number of nodes, a flow similar to that of FIG. 3 may be suitable for announcing routes to other nodes in the mesh network. For example, an announcing node may transmit in its discovery signaling a list of all the nodes with which the announcing node has direct links, a list of all the nodes in the mesh network to which the announcing node knows a route, or a list of selected nodes which the announcing node has links. However, in a larger mesh network, the traffic of announcement messages may be problematic, especially if many nodes announce their routing information simultaneously. Such signaling in a mesh network with many nodes could be expected to cause a high level of congestion and consume a large amount of bandwidth. In addition, a large portion of the discovery signaling in such a scenario may be redundant: For example, UE A announces that it has a link with UE B, and UE B also announces that it has a link with UE A. Thus, the model of FIG. 3 may be most suitable for the specific case of announcing links to the network, rather than as a general solution to distributing routing table information in a mesh network.

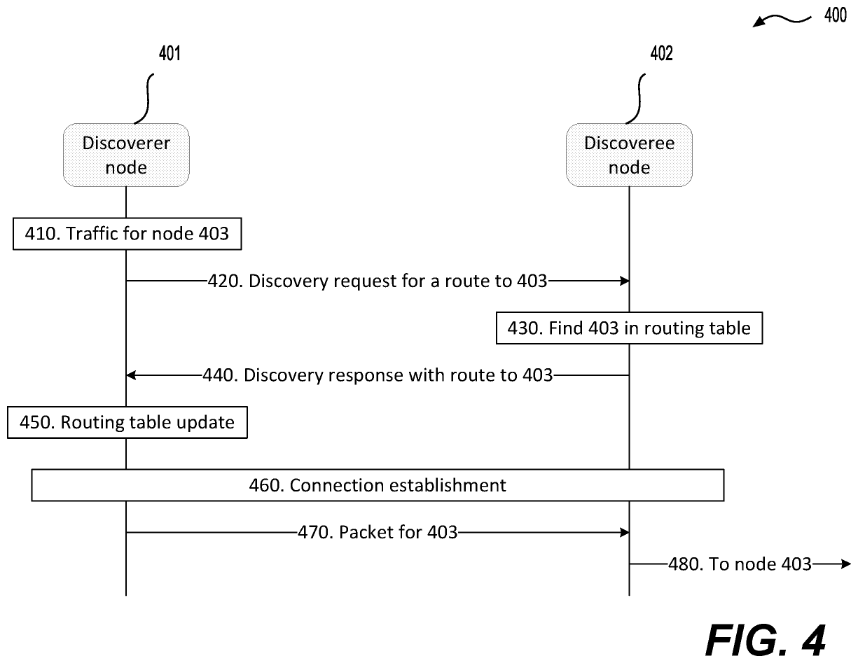

FIG. 4 shows an exemplary discovery procedure in which a discoverer node requests from a discoveree node a route to a destination node (resembling the legacy discovery Model B) according to embodiments of the disclosure. The procedure of FIG. 4 may be seen as complementary to the procedure of FIG. 3, and both procedures could coexist in a mesh network. For example, the procedure of FIG. 3 may be used to announce links to the network, and the procedure of FIG. 4 may be used to determine links between devices. In step 410 of FIG. 4, the discoverer node 401 generates traffic to be transmitted to node 403 (not shown), to which the discoverer node 401 does not know a route. In step 420, the discoverer node 401 transmits (for instance, by broadcast) a first discovery message including a request for a route to node 403. The first discovery message is received by one or a plurality of discoveree nodes. (FIG. 4 shows only a single discoveree node 402, but the same or similar steps may be carried out by multiple discoveree nodes independently.)

In step 430, the discoveree node 402 consults its routing table and finds at least one route to node 403. Step 430 may include a selection by the discoveree node 402 of a preferred route from among a plurality of known routes to node 403. Alternatively, step 430 may identify a plurality of routes to node 403 instead of selecting a single preferred route. There may be multiple discoveree nodes involved within step 430, and as a consequence, each discoveree node finds at least one route towards node 403 independently. A single discoveree node is shown in FIG. 4, but the same steps may be carried out by any additional discoveree nodes. (Other nodes may also receive the first discovery message but find that they do not know any route to node 403. Such other nodes may determine not to respond to the first discovery message, and hence they may not function as discoveree nodes.)

In step 440, the discoveree node 402 sends a second discovery message to the discoverer node 401, including an indication of at least one route to node 403. The indication in the second discovery message may include detailed information about the route (for example, a number of hops, a weighting or quality measurement of the route, a list of all nodes on the route, etc.), or it may only indicate that a route to 403 through the discoveree node exists. The message of step 440 may be sent using any “cast type”; that is, the message may be sent by unicast (to the discoverer node 401 only), by broadcast (to any node that can receive this message), or by groupcast (to an identified set of nodes including the discoverer node 401). In step 440, the discoverer node 401 may receive multiple discovery responses (i.e., the second discovery message) from a plurality of discoveree nodes.

In step 450, the discoverer node receives the second discovery message and updates its routing table with the information that the discoveree node 402 is a potential next hop for a route to node 403. The information in the routing table may take various forms. The update to the routing table may include storing only the information that the discoveree node 402 can be used as a next hop for delivery to node 403; alternatively, the update to the routing table may include storing further information about at least one route from the discoveree node 402 to node 403, such as a number of hops, a weighting or quality assessment of the route, a list of all nodes along the route, etc.

The information stored in the routing table may include information extracted from the second discovery message, and/or the stored information may include information determined by the discoverer node 401; for example, the discoverer node 401 may infer a quality of the route from itself to node 403 based on a combination of information about its link to the discoveree node 402 and any information provided by the discoveree node 402 about the quality of the route from the discoveree node 402 to node 403. The discoverer node may also store the information that there is at least one route to node 403, so that a subsequent discovery procedure initiated by a different node in the role of the discoverer node may cause this node to act as the discoveree node 402 for a route to node 403.

In step 460, the discoverer node 401 establishes a connection (for example, a PC5 unicast link and/or a PC5-RRC connection) with the discoveree node 402. In step 470, the discoverer node transmits a packet of data to the discoveree node 402 for delivery to node 403. In addition to the data packet itself, the transmission of step 470 may include routing information, such as an identification of a preferred route to node 403, an intermediate destination to be used in the route to node 403, a maximum number of hops or time-to-live (TTL) for the packet, and so on.

In step 480, the discoveree node 402 forwards the packet along an identified route towards node 403. The forwarding in step 480 may include establishment of a connection by the discoveree node 402 with a node included in the route to node 403. The transmission of step 480 may include routing information, such as an identification of a preferred route to node 403, an intermediate destination to be used in the route to node 403, a maximum number of hops or TTL for the packet, and so on. The routing information may be derived from routing information provided by the discoverer node in step 470 (for example, information in a header of the packet that was transmitted at step 480) and/or from information known to the discoveree node 402.

In the description of the subsequent figures, for succinctness, we use the phrases “discovery request for X” and/or “route request for X” to mean “discovery request including a request for a route to node X”, and “discovery response for X” and/or “route response for X” to mean “discovery response including information on a route to node X”. Step 420 of FIG. 4 is an example of a discovery request for node 403, and step 440 of FIG. 4 is an example of a discovery response for node 403.

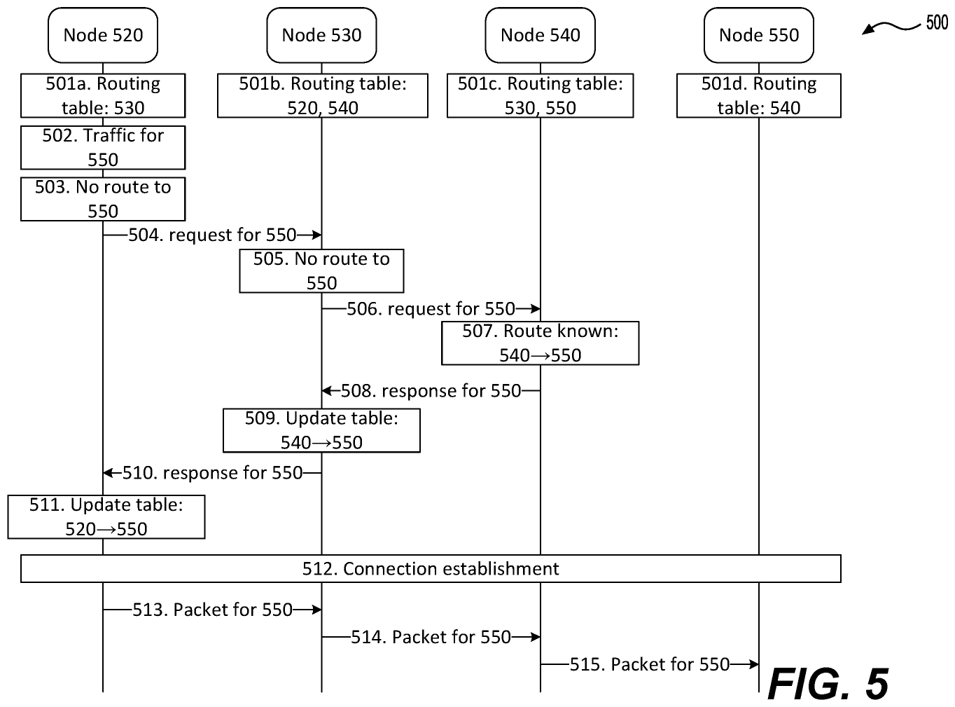

FIG. 5 shows an exemplary discovery procedure 500 in a mesh network including the maintenance of routing tables at a plurality of nodes and the delivery of a packet, according to embodiments of the disclosure. The procedure 500 involves multiple hops between the source and destination of a data packet. The mesh network of FIG. 5 includes (at least) four nodes 520, 530, 540, and 550. All nodes are connected in a linear fashion (520↔530↔540↔550). Each node initially knows only the routes to its immediate neighbors.

In step 501 of FIG. 5, node 520 knows the (single-hop) route to 530 (step 501a). Node 530 knows the (single-hop) routes to 520 and 540 (step 501b). Node 540 knows the (single-hop) routes to 530 and 550 (step 501c). Node 550 knows the (single-hop) route to 540 (step 501d).

In step 502 of FIG. 5, node 520 determines that there is traffic (in the broadest sense, including any data to transmit, such as service establishment information, control signaling, user data, or any other information) to deliver to node 550.

In step 503, node 520 consults its routing table and determines that there is no route to node 550. Node 520 initiates discovery to find a neighbor node in the mesh network with a route to node 550.

In step 504, node 520 transmits a first discovery request for node 550. The discovery request may be sent by unicast to node 530 (the only neighbor to which node 520 knows a route), by groupcast to a group address for a group that includes node 530, by broadcast to any node that can receive the message, and so on.

In step 505, node 530 receives the discovery request, consults its own routing table, and determines that there is no route to node 550.

In step 506, node 530 transmits a second discovery request for node 550. this request message may include a forwarded copy of the first discovery request from step 504, or the second discovery request may be a new message generated by node 530, with or without information copied from the message in step 504.

In step 507, node 540 receives the second discovery request, consults its routing table, and determines a route to node 550, specifically the direct route 540↔550.

In step 508, node 540 sends a first discovery response for node 550, including information about the route to node 550. This message may include an explicit description of the route, partial information about the route such as a hop count and/or a quality metric, or only the information that a route exists. The first discovery response may include identifying information, such as a transaction identifier and/or a sequence number, that associates the first discovery response with the second discovery request.

In step 509, node 530 receives the first discovery response and updates the routing table of node 530 with the information that node 540 is a valid next hop or intermediate destination for a route to node 550. At this stage, any information derived from the first discovery response may be stored in the routing table at node 530.

In step 510, node 530 determines a route to node 550 and responds to the first discovery request by transmitting to node 520 a second discovery response for node 550. The second discovery response may include any information about the route to node 550. The second discovery response may include identifying information, such as a transaction identifier and/or a sequence number, that associates the second discovery response with the first discovery request.

In step 511, node 520 receives the second discovery response and updates its routing table to include at least a route to node 550. Depending on the information provided in the second discovery response in step 510, node 520 may populate its routing table with additional information, such as a route to 540, and any available information about the route from node 530 to node 550. Since node 520 now knows a route through the mesh to node 550, node 520 can begin preparations for transmitting its data to node 550.

In step 512, any necessary connection establishment between nodes takes place. this step is further discussed after the introduction of the whole procedure.

In step 513, node 520 transmits to node 530 (in accordance with its stored route to 550) a packet of data for node 550. The packet of data may include a protocol data unit (PDU) of a protocol layer responsible for handling packet data, such as a packet data convergence protocol (PDCP) layer. The contents of the packet of data may include user data, control signaling, service establishment information, or any other information.

In step 514, node 530 forwards to node 540 (in accordance with its own stored route to 550) the packet of data for node 550.

In step 515, node 540 forwards to node 550 (in accordance with its own stored route to 550) the packet of data for node 550, completing the delivery of the data packet. Subsequent data packets exchanged between nodes 520 and 550 may follow a similar procedure.

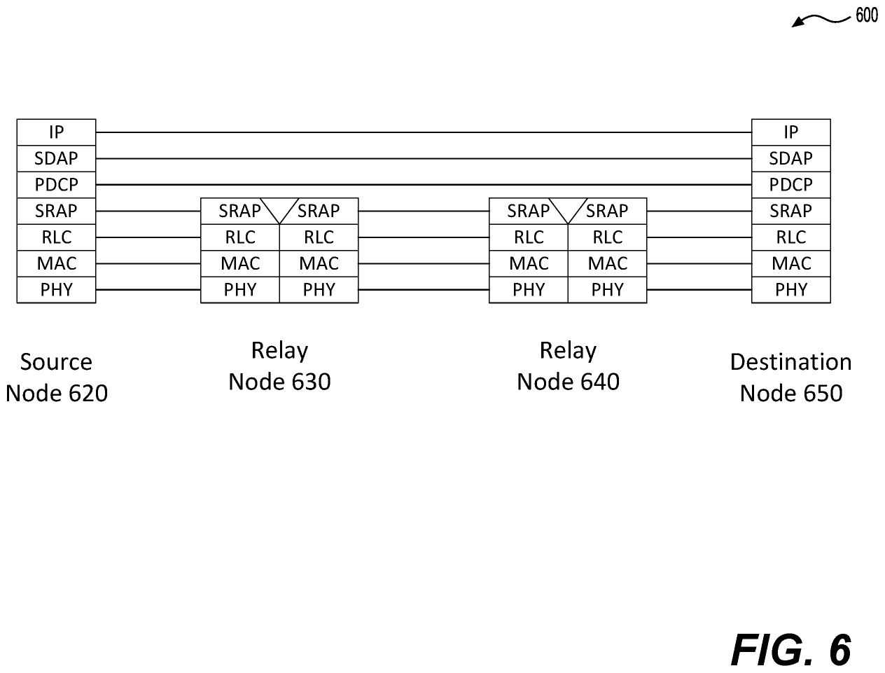

The connection establishment in step 512 of FIG. 5 may include multiple steps. For example, it may be necessary for nodes 520 and 550 to establish a logical connection (such as a PC5 unicast link and/or a PC5-RRC connection) in order to handle transmissions of application data between the two nodes. It may be necessary for pairs of adjacent nodes in the mesh network (for example, nodes 520 and 530, nodes 530 and 540, nodes 540 and 550) to establish logical connections (such as PC5 unicast links, RRC connections, and/or PC5-RRC connections) in order to handle communication over the direct interface, reception and forwarding of data packets, control signaling, and so on. Step 512 may be broken up into multiple steps that may occur at different stages of the procedure. For example, node 530 may establish a connection with node 540 after step 518, in response to node 530 learning that node 540 has a route to node 550. Alternatively, node 530 may establish a connection with node 540 after step 513, in response to node 530 receiving a data packet that is intended to be forwarded to node 550 (and hence connectivity between nodes 530 and 540 for the forwarding is necessary). It may not be necessary to establish logical connections between non-adjacent nodes of the mesh network with the exception of the “endpoint” nodes 520 and 550 (for instance, between nodes 520 and 540, or between nodes 530 and 550). A logical connection established between the endpoint nodes (e.g., nodes 520 and 550) for the purpose of end-to-end data transmission may be associated with a different protocol structure from a logical connection established between adjacent nodes (e.g., nodes 520 and 530) for the purpose of data forwarding. For example, the logical connection between the endpoints may be associated with higher-layer protocol entities that are not necessary for the logical connection between the adjacent nodes. This protocol structure is discussed further in the context of FIG. 6.

FIG. 6 shows an exemplary user-plane protocol stack for a layer 2 mesh network, using the same node nomenclature and network topology as FIG. 5, according to embodiments of the disclosure. Nodes 620, 630, 640, and 650 correspond to nodes 520, 530, 540, and 550 in FIG. 5, respectively. Nodes 620 and 650 exchange data belonging to an upper layer, such as an internet protocol (IP) layer. One or more layers of the protocol stacks below this upper layer may be terminated end-to-end between nodes 620 and 650. FIG. 6 shows end-to-end termination of a service data adaptation protocol (SDAP) layer and a PDCP layer. A layer of the protocol stacks may support relaying operation, through which transmissions from a first node can be forwarded to a second node that may not be topologically adjacent to the first node. FIG. 6 shows relaying operation in an SRAP layer. One or more layers of the protocol stacks may be terminated hop-by-hop between adjacent pairs of nodes in the mesh, such as between nodes 620 and 630, between nodes 630 and 640, or between nodes 640 and 650. FIG. 6 shows hop-by-hop termination of a radio link control (RLC) layer, a medium access control (MAC) layer, and a physical (PHY) layer. In an analogous control-plane protocol stack (not shown), the IP and SDAP layers may be replaced by one or more control protocol layers, such as a PC5-RRC layer and/or a PC5-S layer. In an embodiment, these user-plane and/or control-plane protocol stacks may allow the maintenance and use of end-to-end radio bearers between nodes 620 and 650 for the transport of data (including user data and/or control signaling). Some functions, such as security, may be necessary to terminate end-to-end between nodes 620 and 650, so that intermediate nodes such as nodes 630 and 640 do not have access to the cleartext contents of packets exchanged between nodes 620 and 650. In an embodiment, security may be maintained as a function of the PDCP layer. In an embodiment, security may be maintained in a higher layer (not shown in FIG. 6), such as an IPsec layer above or in place of the IP layer.

Other forms of protocol stacks can be considered for mesh network operation without substantially affecting the discovery procedures and related route-finding functionality. In an embodiment, a “layer 3 mesh network” in which the packet forwarding functionality is embodied in a higher layer of the protocol stack (for example, an IP layer) may employ the discovery procedures described herein.

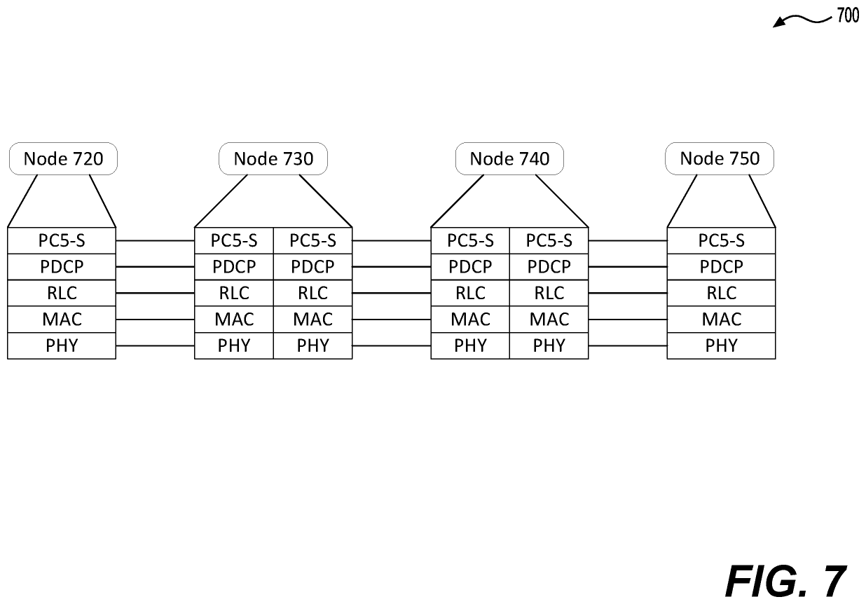

It should be noted that discovery operations between nodes in a mesh network may employ different protocol stacks compared to data communication. FIG. 7 shows an exemplary discovery protocol stack for a mesh network, in which discovery is controlled by a PC5-S protocol, according to embodiments of the disclosure. (Other upper-layer protocols comprising discovery signaling may be substituted for PC5-S in FIG. 7.) Nodes 720, 730, 740 and 750 correspond to nodes 520, 530, 540 and 550 in FIG. 5 respectively. In FIG. 7, a PC5-S layer, a PDCP layer, an RLC layer, a MAC layer, and a PHY layer are all terminated hop-by-hop between adjacent nodes in the mesh. There is no exchange of discovery signaling between non-adjacent nodes. In an embodiment, the endpoint nodes (in this example, nodes 720 and 750) may terminate an entity of a control protocol such as PC5-S for other purposes besides discovery. In an embodiment, nodes 720 and 750 may establish end-to-end termination of a PC5-S protocol layer for maintenance of a PC5 unicast link, while also maintaining hop-by-hop termination of separate PC5-S protocol entities with their adjacent peer nodes (as shown in FIG. 7) for discovery signaling.

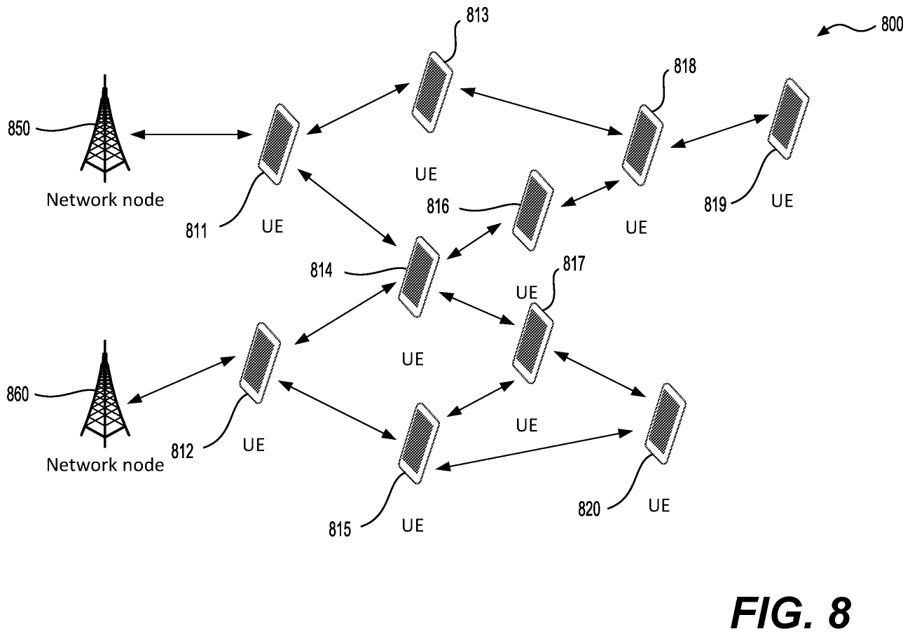

FIG. 8 shows an exemplary mesh network topology, including both network nodes and mobile devices, that will be used to clarify subsequent descriptions of procedures according to embodiments of the disclosure. The mesh network contains two network nodes (850 and 860) and ten mobile nodes (811, 812, 813, 814, 815, 816, 817, 818, 819, and 820), variously connected with one another as shown in FIG. 8. Each node has a routing table (not shown in FIG. 8) that contains, at minimum, knowledge of its direct links to adjacent peer nodes.

In FIG. 8, suppose that node 818 has a packet to transmit to the network, but node 818 does not initially know a route to the network but only knows the direct routes to its immediate peers 813, 816, and 819. Accordingly, node 818 may transmit to its peers (by broadcast, groupcast, or unicast) one or more discovery messages soliciting a route to the network. The peer nodes that receive the discovery message(s) may apply the procedures previously described, together with various heuristics related to the topology of the mesh network and the contents of their routing tables, to determine their responses. As exemplary behaviors:

1. Node 819 has only one connection, namely its connection to node 818, so node 819 may be unable to offer any useful routing information to node 818 and may not respond to the discovery message(s). Alternatively, node 819 may have information in its routing table concerning other nodes in the mesh network. Although node 819 itself is not a useful destination on a route to the network from node 818, node 819 may respond with routing information about other nodes (for example, node 819 may send a response indicating that node 811 has previously been indicated as having a connection to the network).

2. Node 816 has one connection other than its connection to node 818, which is to node 814. Depending on the information in its routing table, node 816 may apply any of the following behaviors:

2a. In response to node 816's routing table containing the information that node 811 has a route to the network (but not an actual route to node 811), node 816 may respond with that information.

2b. In response to node 816's routing table containing the information that node 811 has a route to the network (for example, the route 816→814→811→network node 850), node 816 may send a response to the discovery message(s) with the information that 816 can serve as a next hop in a route to the network. In this case the response may contain further information about the route(s) to the network, such as a number of hops (which, depending on the numbering convention, may be considered as two hops corresponding to intervening nodes 814 and 811, or as three hops corresponding to the links 816→814, 814→811, and 811→network node 850), information on the quality of the route, a full list of the hops constituting the route, etc.

2c. In response to node 816's routing table not containing information on a route to the network, node 816 may transmit a discovery message (either by forwarding the discovery message from 818, or by creating a new discovery message of its own) to its other connection at node 814. This transmission may eventually result in a multi-hop cascade of discovery messaging similar to the flow shown in FIG. 5. This transmission culminates in node 818 learning a route to the network through 816 (for example, 818→816→814→811→network node 850 and/or 818→816→814→812→network node 860).

3. Node 813 has one connection other than its connection to node 818, to node 811. Node 813 may show similar behavior to the alternatives described above for node 816.

4. In response to node 814 receiving a discovery message from node 816 (as described in item 2c above), node 814 may be aware based on information in its routing table that it has at least two possible links to the network, via node 811 and via node 812. If node 814 is not initially aware of these routes, node 814 may learn one or both of them through exchanging discovery signaling with its neighbors 811, 812, and 817 according to the procedures previously described.

5. The possibility of discovery signaling being transmitted from node 814 to node 817 is of interest, because 817 has routes to the network that do not pass through node 814 (817→815→812→network node 860 and 817→820→815→812→network node 860). Accordingly, if node 814 solicits a route to the network, node 817 may respond to the solicitation. Node 817 may appear that from 814's perspective, the routes to the network through 817 are suboptimal, since they all involve extra hops compared to the more direct route 814→812→network node 860.

5a. Node 814 may be capable of evaluating the route(s) through 817 and determining that they are suboptimal when populating its own routing table. In an embodiment, node 814 may record the route 817→815→812→network node 860 in its routing table, with the information that the route is four hops long, while also recording other, shorter routes with their own hop count information. This information in the routing table may be useful, for example, in case a shorter route to the network breaks, such as the case of link failure between 814 and 812 and/or between nodes 814 and 811.

5b. In response to other criteria besides route length (for example, the quality of radio links) are evaluated, the shortest route may not be the best route. For example, if the link 814→812 is of poor quality but the links 814→817, 817→815, and 815→812 are all of good quality, it may be reasonable to deliver a packet via the longer path 814→817→815→812→network node 860 rather than via the shorter (but potentially less reliable) path 814→812→network node 860. This longer path may be especially useful if a service has a high reliability requirement but can tolerate the latency of the additional hops.

6. Nodes with a connection to the network, such as nodes 811 and node 812 in FIG. 8, may employ a distinct “Model A-like” discovery procedure to advertise their availability. Thus, for instance, nodes 811 and 812 may advertise to their neighbors that they are connected to the network, meaning that nodes 813, 814, and 815 learn routes to the network. In an embodiment, nodes 813, 814, and 815 may proceed to advertise themselves as having connectivity to the network. For example, if node 811 advertises “I have a 1-hop link to the network”, node 813 may subsequently advertise “I have a 2-hop link to the network” (or “I have a 2-hop link to the network via 811”), potentially leading 818 to advertise “I have a 3-hop link to the network” (or “I have a 3-hop link to the network via 813 and 811”). This propagation of network routes may reduce the necessity for discovery solicitations, at the cost of increased traffic in the network from the route advertisements.

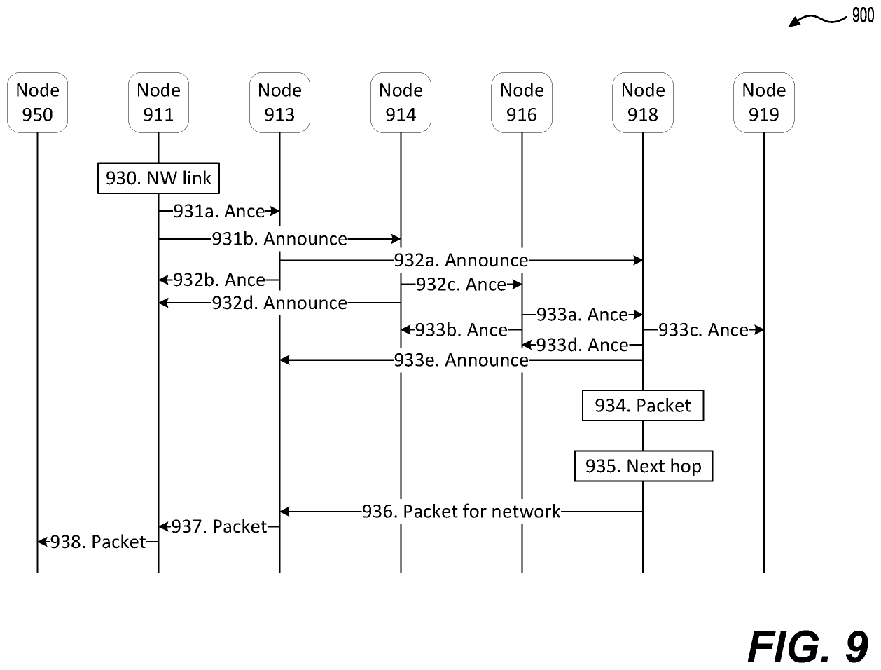

FIG. 9 shows an exemplary discovery procedure 900 in a mesh network where a distinguished node has a link to a cellular network according to embodiments of the disclosure. Nodes 911, 913, 914, 916, 918, 919, and 950 correspond to nodes 811, 813, 814, 816, 818, 819, and 850 in FIG. 8, respectively. FIG. 9 shows an exemplary message flow for the transmission of a packet to the network from node 818 in the network of FIG. 8, presuming that node 911 proactively advertises its connection to the network and that other nodes subsequently advertise a route to the network via node 911. Not all nodes of the network are shown in the diagram to save the space, but the principles of the flow could be applied throughout the network as described herein.

In step 930, node 911 starts the procedure with awareness of its link to network node 950. In step 931, node 911 transmits to its neighbor nodes (for example, by broadcast or groupcast) an announcement of its link to node 950, which may, for instance, indicate that node 931 has a 0-hop route to 950 (using the convention that hops are counted based on intervening nodes—a direct connection is zero hops, a singly relayed connection is one hop, and so on). The announcement of step 931 is received by the neighbor nodes 913 (Step 931a) and 914 (Step 931b).

In step 932, nodes 913 and 914 update their routing tables and announce their availability for routes toward node 950. The announcements from nodes 913 and 914 may, for instance, indicate that 913 and 914 have 1-hop routes to node 950. The announcement from node 913 is received by its neighbors 911 (Step 932b) and 918 (Step 932a), and the announcement from node 914 is received by its neighbors 911 (Step 932d) and 916 (Step 932c). Node 911 may discard the announcements from nodes 913 and 914 without updating its routing table, since the routes being advertised go through 911 itself. Alternatively, nodes 913 and 914 may avoid “re-advertising” the announcement to node 911 because node 911 appears in the route.

In step 933, nodes 918 and 916, which received announcements in step 932, update their routing tables and announce their availability for routes toward the network. The announcement from node 916 is received by its neighbors 914 (Step 933b) and 918 (Step 933a), and the announcement from 918 is received by its neighbors 913 (Step 933e), 916 (Step 933d), and 919 (Step 933c). Similar to the redundant routing information provided to node 911 in step 932, the information sent in step 933 to nodes 913 and 914 may be discarded or omitted. The reason is that the route being advertised by 918 goes through 913, and the route being advertised by node 916 goes through node 914. After step 933, nodes 916 and 918 may each be aware of two distinct routes to node 950: Node 916 knows the routes 916→914→911→950 and 916→918→913→911→950, while node 918 knows the routes 918→913→911→950 and 918→916→914→911→950.

In step 934, node 918 acquires (for example, from an application protocol layer) a packet for delivery to the network (represented in FIG. 9 by node 950). In step 935, node 918 consults its routing table to determine at least one next hop for transmission of the packet towards the network, specifically towards node 950 (which may be the only network node to which node 918 knows a route). In this instance, node 918 selects node 913 as the next hop (this may, for example, be the result of preferring the route with the fewest hops). In step 936, node 918 transmits the packet to node 913, the selected next hop. In step 937, node 913 consults its routing table, selects node 911 as the next hop to node 950, and transmits the packet to node 911. In step 938, node 911 delivers the packet to node 950.

In an embodiment, a transmitting node may select more than one next hop, resulting in multiple transmissions of a particular packet towards the same ultimate destination. For example, in the flow of FIG. 9, node 918 could select both nodes 913 and 916 as valid next hops towards node 950, resulting in transmitting two copies of the packet in step 936. Such packet duplication could be useful, for example, for high-reliability services where redundant transmission would help to meet a reliability requirement.

In an embodiment, a transmitting node may select different next hops for different packets, resulting in a diversity of routes towards the destination node for the packets. Such routing diversity could be useful, for example, in achieving higher data rates by transmitting on multiple links in parallel, or in increasing the chances that at least some packets of a particular flow reach the destination (in case the service can benefit from partial data reception, e.g., by allowing lost packets to be wholly or partially reconstructed through techniques like upper-layer coding).

Connection establishment procedures are omitted from FIG. 9, but they may be necessary before transmission of the packet in steps 936-938. In an embodiment, node 918 may avail itself of the advertised routes to establish a logical connection (for example, an RRC connection) with the network after step 933 (when a route to the network is available) or after step 934 (when the packet is sent). In another embodiment, pairs of adjacent nodes in the mesh network may establish connections with one another after exchanging discovery messaging and/or when a packet is delivered. In the flow shown in FIG. 9, node 918 may establish a connection (for example, a PC5 unicast link and/or a PC5-RRC connection) with node 913 after step 932 (when node 918 learns that 913 is a valid next hop to the network) or after step 935 (when node 918 selects 913 as a next hop for transmission of a packet to the network). In another embodiment, node 913 may establish a connection with node 911 after step 931 or after step 936, and node 911 may establish a connection with network node 950 (for example, an RRC connection) at the beginning of the procedure or after step 937.

The full details of routing procedures in the nodes of the mesh network are not shown in FIG. 9. When node 918 transmits its packet in step 936, the packet may include various pieces of routing information, such as an indication that the network is the destination, an indication of a preferred or required route to the network, a maximum number of hops or TTL, and so on. This information may be used by subsequent nodes (such as nodes 913 and 911 in the example) for routing. In an embodiment, node 913 may consult its routing table to select a next hop to node 950 after step 936 and before step 937.

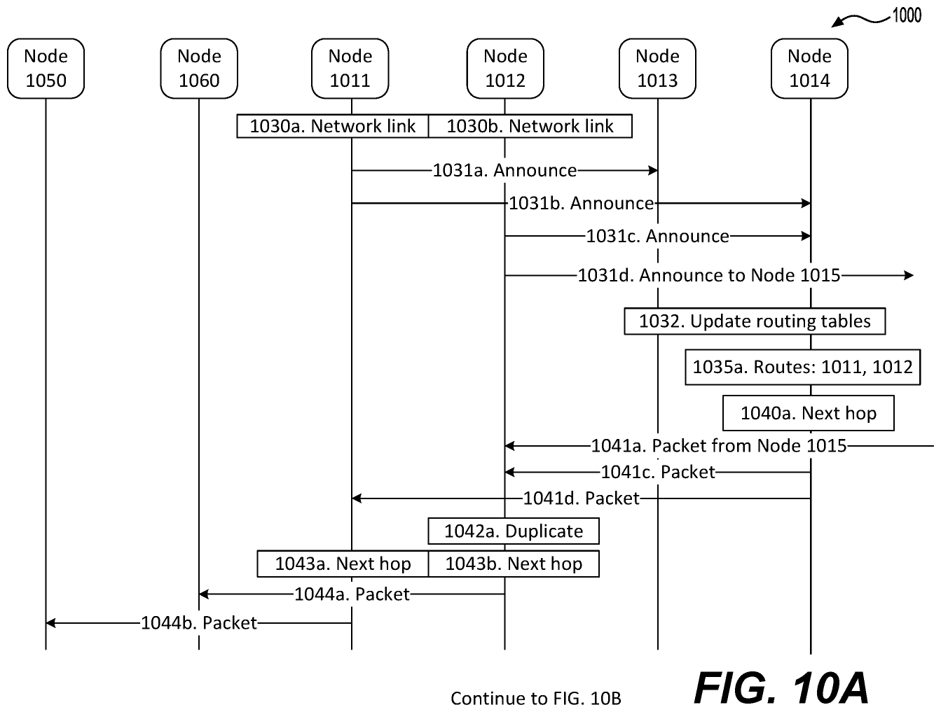

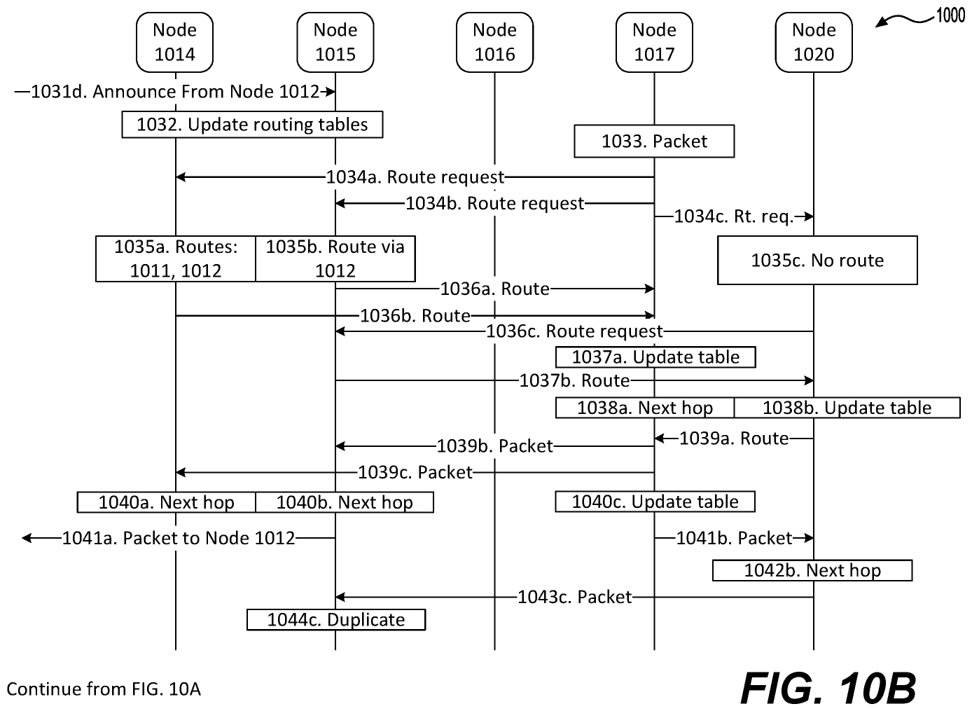

FIG. 10A-10B, using the same example network shown in FIG. 8, shows an exemplary discovery procedure 1000 in a mesh network where a source node is provided with routes to a plurality of nodes of a cellular network according to embodiments of the disclosure. Nodes 1011, 1012, 1013, 1014, 1015, 1016, 1017, 1020, 1050, and 1060 correspond to nodes 811, 812, 813, 814, 815, 816, 817, 820, 850, and 860 in FIG. 8, respectively. At step 1030 of FIG. 10A, nodes 1011 and 1012 are aware of their direct links to the network nodes (1050 and 1060, respectively).

In step 1031, node 1011 sends to its neighbors, 1013 (Step 1031a) and 1014 (Step 1031b), an announcement of its link to the network, and node 1012 sends to its neighbors, nodes 1014 (Step 1031c) and 1015 (Step 1031d), an announcement of its link to the network. In this example, the receiving nodes 1013, 1014, and 1015 are assumed not to forward the announcement to their own neighbors (as described previously, such forwarding is technically possible, resulting in more nodes in the network having their routing tables populated with information about one or more routes to the network).

In step 1032, nodes 1013, 1014, and 1015 all update their routing tables according to the announcements they received in step 1031. In step 1033, node 1017 generates a packet to be delivered to the network; since node 1017 has no route to the network, node 1017 may request a route from its neighbors.

In step 1034, node 1017 transmits to its neighbors, 1014 (Step 1034a), 1015 (Step 1034b), and 1020 (Step 1034c), a request for a route to the network, i.e., a discovery request for the network. The request in step 1034 may include criteria for a desired route (e.g., a maximum hop count, quality-of-service criteria, etc.). The request may include information about a preferred network node, or may be node-agnostic, i.e., the request may indicate only that a route to some network node is necessary.

In step 1035, nodes 1014 (Step 1035a), 1015 (Step 1035b), and 1020 (Step 1035c) consult their routing tables, with varying results: node 1014 determines that it has two routes to the network (via nodes 1011 and 1012), node 1015 determines that it has one route to the network (via node 1012), and 1020 determines that it has no known route to the network.

In step 1036, these nodes proceed according to the outcomes of step 1035: node 1014 responds to node 1017 with an indication of at least one route to the network (Step 1036b); node 1015 responds to node 1017 with an indication of a route to the network (Step 1036a); and node 1020 does not respond to node 1017 (Step 1036c), but instead sends to its own neighbor, node 1015, a request for a route to the network, i.e., a discovery request for the network. The response from node 1014 in step 1036 may contain an indication of multiple routes, detailed information about one or more of the routes, or only the information that at least one route exists.

In step 1037, node 1017 updates its routing table according to the responses received from nodes 1014 and 1015 in step 1035 (Step 1037a), and node 1015 responds to 1020 with an indication of a route via node 1012 to the network (Step 1037b). In this example, node 1017 determines to send its packet to both nodes 1014 and 1015 for routing to the network. This determination may reflect a reliability requirement of the underlying service, a throughput requirement of the underlying service, and so on. (In other examples, node 1017 might determine to send its packet to only one of nodes 1014 and 1015 at this stage.)

In step 1038, node 1017 consults its updated routing table to determine the next hop(s) for transmission of its packet towards the network (Step 1038a), and 1020 updates its routing table according to the response received from 1015 in step 1037b (Step 1038b).

In step 1039, node 1017 transmits its packet to node 1014 (Step 1039c) and node 1015 (Step 1035b). Both nodes 1014 and 1015 are selected as next hops in step 1038. Node 1020 transmits to node 1017 an indication of a route to the network (Step 1039a).

In step 1040, nodes 1014 (Step 1040a) and 1015 (Step 1040b) consult their routing tables to determine respective next hops for the packet of which they received copies in steps 1039c and 1039b, and node 1017 updates its routing table according to the route received from 1020 in step 1039a (Step 1040c). From step 1036 to step 1040, different nodes 1014, 1015 and 1020 independently handle the route request from node 1017. Then nodes 1014, 1015, and 1020 may independently respond by sending corresponding route information back to node 1017. In this example, the route information received from node 1020 comes a bit late compared to the route information from nodes 1014 and 1015, as node 1020 exchanges with other nodes before the transmitting the route information. Node 1017 may update the routing table in case of valid route information received. Node 1017 may proceed to route the packet according to its own decision. This decision may be governed, for instance, by the availability of the discovered route(s), by a supervisory timer determining when the packet may be transmitted, by taking into account the allowable latency for the packet, by considering the quality of the available routes, and so on. In this example, node 1017 determines to transmit an additional copy of its packet to node 1020 for forwarding to the network. In an embodiment, node 1017 may determine that the packet has already been transmitted into the mesh network and another copy is not necessary to be sent.

In step 1041, node 1014 forwards the packet to its neighbors 1011 (Step 1041d) and 1012 (Step 1041c), node 1015 forwards the packet to its neighbor node 1012 (Step 1041a), and node 1017 transmits the additional copy of the packet to node 1020 (Step 1041b).

In step 1042, node 1012 recognizes that it has received a duplicate copy of the packet in step 1041 (i.e., node 1012 has received copies from both 1014 and 1015) and may discard a copy of the packet (Step 1042a). Node 1020 consults its routing table to determine a next hop for transmission of the packet (Step 1042b). In accordance with the route received by node 1020 in step 1037b, node 1020 selects node 1015 as the next hop towards the network. In an embodiment, the duplicate detection at node 1012 in step 1042a may be carried out in an SRAP layer or a similar protocol layer responsible for routing functionality in the mesh. In an embodiment, node 1012 may not perform duplicate detection, and subsequent steps may involve transmission of additional copies of the packet as a result, with the assumption that duplicates will be handled in other stages of the procedure (for instance, in an upper protocol layer after copies of the packet are received by the network).

In step 1043, nodes 1011 (Step 1043a) and 1012 (Step 1043b) consult their routing tables to determine respective next hops for transmission of the packet, and node 1020 forwards the packet to 1015 in accordance with the selection in step 1042b (Step 1043c).

In step 1044, nodes 1011 (Step 1044b) and 1012 (Step 1044a) forward the packet to network nodes 1050 and 1060 respectively, and node 1015 recognizes that it has previously forwarded this packet and may discard the packet as a duplicate (Step 1044c). In an embodiment, node 1015 may continue to transmit the packet at this stage instead of discarding the packet, as a reliability measure in case previous copies of the packet have been lost. After step 1044, the packet has been successfully delivered to the network (twice), no further copies of the packet are circulating in the mesh network, and the procedure is complete. The network may subsequently handle the duplicated packet according to various well-known techniques to prevent duplicate data from being delivered to an application layer. In an embodiment, a protocol layer, such as a PDCP layer, may be shared between the two network nodes 1050 and 1060, and the PDCP layer may perform duplicate detection.

As with previous examples shown in FIG. 5 and FIG. 9, the establishment of connections between various pairs of nodes in the mesh is not shown in FIG. 10A-10B. Node 1017 may establish a connection with the network during the process in order to exchange data with the network (for example, after step 1036, when node 1017 first learns a route to the network). The connection may be an RRC connection. and node 1017 may use the routing facilities of the mesh network to exchange control signaling with the network to establish such a connection before transmitting a user data packet. If node 1017 establishes a connection with a specific network node—for instance, node 1050—at this stage, node 1017 may select one or more next hops for transmission of its packet based on their ability to route to node 1050 specifically. If node 1017 establishes a connection with a plurality of network nodes—for instance, dual connectivity with nodes 1050 and 1060—then node 1017 may transmit its packet to neighbor nodes that can offer a route to any of the network nodes with which 1017 has a connection. There may further be a requirement for adjacent pairs of nodes in the mesh to establish a connection (for example, a PC5-RRC connection) to support data transmission between the nodes, so that, for instance, node 1017 may establish connections with nodes 1014 and 1015 during the procedure (for example, after step 1038, when node 1017 has determined that it could transmit its packet to both nodes 1014 and 1015). Accordingly, such adjacent pairs of nodes may terminate one or more protocol layers between them (such as a PC5-RRC protocol, a PC5-S protocol, and so on) to manage such connections.

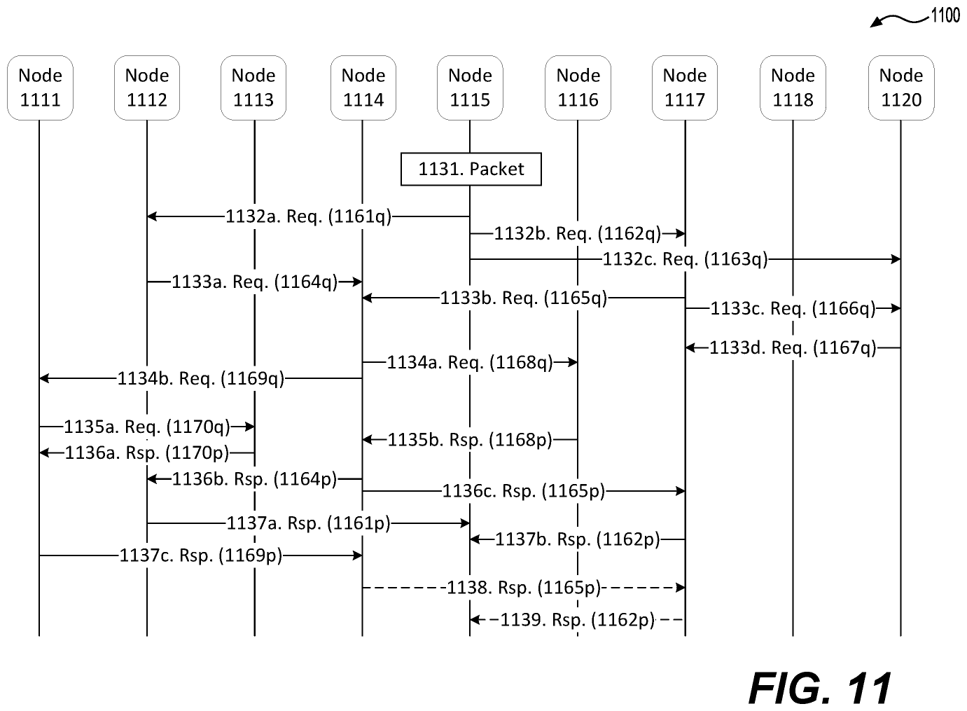

FIG. 11, using the same example network, shows an exemplary discovery procedure 1100 in a mesh network, similar to Model B as described previously, where a source node is provided with at least one route to a destination node according to embodiments of the disclosure. Nodes 1111, 1112, 1113, 1114, 1115, 1116, 1117, 1118, and 1120 correspond to nodes 811, 812, 813, 814, 815, 816, 817, 818, and 820 in FIG. 8, respectively. In this example, node 1115 has a packet of data to transmit to node 1118. Initially, we assume that each node has no routing information other than the direct links to its neighbors in the mesh network. Each route request and its corresponding response are shown with the same sequence number but different alphabet suffixes (“q” for request and “p” for response) to help distinguish which messages are responsive to one another.

In step 1131 of FIG. 11, node 1115 generates a packet for transmission to node 1118, and since node 1115 does not have node 1118 in its routing table, node 1115 starts a discovery procedure to determine a route to node 1118. In step 1132, node 1115 sends a route request to its neighbors, 1112 (step 1132a), 1117 (step 1132b), and 1120 (step 1132c). The three route requests of step 1132 may include a single message sent by broadcast or unicast, but they are shown separately in the flow diagram and given separate sequence numbers (1161q, 1162q, and 1163q respectively), to help associate them with their separate responses.

In step 1133, the following nodes respond to step 1132: node 1112 determines that it does not have 1118 in its routing table, so node 1112 sends a route request to its neighbor, 1114 (step 1133a). (Node 1112 may omit sending a route request to node 1115, since it just received the route request from 1115 in step 1132a. If the route request is sent by broadcast or groupcast, node 1115 may receive the route request, recognize that it already has a discovery operation in progress for the same target node, and discard the route request. For the duration of this example, we do not show route requests as being forwarded back to the requesting node.) Node 1117 determines that it does not have node 1118 in its routing table, so node 1117 sends route requests to its neighbors, nodes 1114 (step 1133b) and 1120 (step 1133c). Meanwhile, Node 1120 determines that it does not have 1118 in its routing table, so node 1120 sends a route request to its neighbor, node 1117 (step 1133d). In step 1134, nodes 1117 and 1120, which received route requests in step 1133, may recognize that they have no constructive way to respond to these requests (each node has already sent a route request to all its neighbors), so they may take no action, while node 1114, which received two route requests from 1112 and 1117 in step 1134, sends route requests to its remaining neighbors, nodes 1111 (step 1134b) and 1116 (step 1134a).

In step 1135, a breakthrough occurs, in that node 1116 determines that it knows a route to 1118. Node 1116 sends a route response which closes transaction number 1168 to node 1114 (step 1135b), while node 1111, which does not know a route to node 1118, sends a route request to its neighbor, node 1113 (step 1135a). In step 1136, node 1113, which does know a route to node 1118, sends a route response which closes transaction number 1170 to node 1111 (step 1136a). Node 1114, which has learned from the response in step 1135b a route to node 1118 via node 1116, sends route responses which close transactions 1164 and 1165 to both 1112 (step 1136b) and 1117 (step 1136c).

In step 1137, the responses continue: node 1112 has now learned a route to 1118 (via nodes 1114 and 1116), so node 1112 sends a route response which closes transaction number 1161 to node 1115 (step 1137a). Node 1117 has now learned a route to node 1118 (via nodes 1114 and 1116), so node 1117 sends a route response which closes transaction number 1162 to node 1115 (step 1137b). Node 1111 has now learned a route to node 1118 (via node 1113), so node 1111 sends a route response which closes transaction number 1169 to node 1114. At this stage, node 1115 has been informed of two routes to the destination node 1118, so node 1115 may now opt to transmit its packet on one route or both (not shown in FIG. 11), or node 1115 may delay transmission while waiting for further route responses. This decision may be governed, by a supervisory timer determining when the packet is transmitted, by taking into account the allowable latency for the packet, by considering the quality of the available routes, and so on.

In step 1138, node 1114 has learned an additional route to node 1118 via nodes 1111 and 1113, so node 1114 may send a route response to 1117 (step 1138a). Since node 1114 previously sent a route response to node 1117 in step 1136c, node 1114 may determine that a second route response is unwarranted (e.g., because the new route via nodes 1111 and 1113 contains more hops than, or is otherwise inferior to, the previously indicated route via 1116) and omit sending the additional route response (shown in dashed line). If node 1114 sends a route response in step 1138, node 1117 learns an additional route to node 1118 (1117→1114→1111→1113→1118), and in step 1139, node 1117 may send a route response to node 1116. If node 1117 sends a route response to node 1115 in step 1139, node 1115 learns an additional route to node 1118 (1115→1117→1114→1111→1113→1118). As discussed previously, node 1117 may determine whether to send (an additional copy of) the packet on this new route (not shown in FIG. 11). This determination may be governed by the reliability and/or latency requirements of an underlying service for the packet, for example.

In an embodiment, to carry out the foregoing example, each node in the mesh may instantiate two algorithms similar to the following ones. A first exemplary algorithm concerns the handling of route requests, as follows:

1. When a first route request for a destination node X is received from a neighbor node Y for a source node Z, record the reception of the route request (potentially including metadata such as a sequence number, a transaction identifier, and so on), consult the routing table for a route to X, and proceed to step 2.

2. If at least one route to X is present in the routing table, send a route response to Y indicating information about the route (potentially including quality information for the route, a number of hops in the route, a list or sequence of the nodes in the route, etc., and potentially including more than one route in the response).

3. Otherwise (no route to X is present in the routing table), send a second route request for destination node X to all neighbors that are neither Y nor Z, with potential exceptions as noted in step 4 below.

4. The second route request of step 3 may be omitted, for example, if the first route request contains a hop count limit or TTL that would be exceeded by the second route request, or if the quality of the link to Y is below a threshold, where link quality may be defined, for example, by a reference signal received power (RSRP) or a reference signal received quality (RSRQ).

In an embodiment, a second exemplary algorithm concerns the handling of route responses, as follows:

1. When a route response for a destination node X is received from a neighbor node W, add the indicated route to the routing table and proceed to step 2.

2. If a route request for destination node X was previously received from a neighbor node V, send a first route response to V indicating the route, with potential exceptions as noted in step 3 below.

3. The first route response of step 2 may be omitted, for example, if any second route response for destination node X was previously sent to V; if a second route response for destination node X was previously sent to V, and the route in the second route response is considered as a better route than the route in the first response, based on various criteria such as one or more link qualities (e.g., RSRP/RSRQ), one or more link weights, a hop count, etc.; if the quality of the route in the first route response is below a threshold, where route quality may be defined by various metrics such as one or more link qualities (e.g., RSRP/RSRQ), one or more link weights, etc.; if the hop count of the route in the first route response exceeds a threshold; and so on.

Throughout the example of FIG. 11, and in the associated algorithms described in the preceding paragraphs, a discovery procedure (including, for example, an exchange of discovery messages as described herein, including information for managing routes between nodes in the mesh) may be accompanied or followed by the establishment of one or more connections between nodes. For example, in the flow of FIG. 11, after node 1115 receives route responses (step 1137) and determines a route to node 1118, node 1115 may initiate a procedure to establish a connection (for example, a PC5-RRC connection) with node 1118. Similarly, node 1115 may initiate a procedure to establish one or more connections with neighboring nodes for the purpose of communication via the mesh network with node 1118.

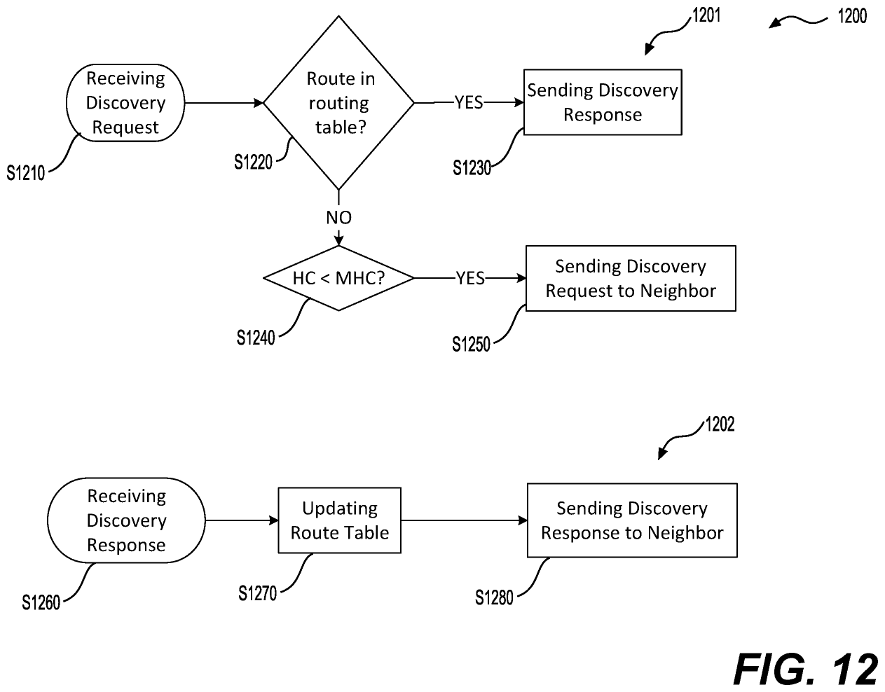

FIG. 12 shows two flowcharts outlining an exemplary process 1200 according to embodiments of the disclosure. In various embodiments, the process 1200 is executed by processing circuitry, such as the processing circuitry in the UE 120. In some embodiments, the process 1100 is implemented in software instructions, thus when the processing circuitry executes the software instructions, the processing circuitry performs the process 1200.

The flowchart 1201 may generally start at step S1210, where the process receives, from a first neighbor node, a first discovery request including a request for a route to a destination node.

At step 1220, it is determined whether the routing table of the first node contains one or more routes to the destination node.

At step 1230, if the routing table of the first node contains one or more routes to the destination node, the first node sends, to the first neighbor node, a discovery response including information about the one or more routes.

At step 1240, if the routing table of the first node does not contain one or more routes to the destination node, it is determined whether the hop count of the discovery request may exceed the maximum hop count.

At step 1250, if the hop count of the discovery request does not exceed the maximum hop count, the first node sends, to a second neighbor node, a second discovery request comprising a request for a route to the destination node.

The flowchart 1202 may generally start at step S1260, where the process receives, from the second neighbor node, a first discovery message including first information about one or more routes to a destination node.

At step 1270, the first node updates its routing table by adding the one or more routes.

At step 1280, the first node transmits, to the first neighbor node, a second discovery response message including second information about the one or more routes.

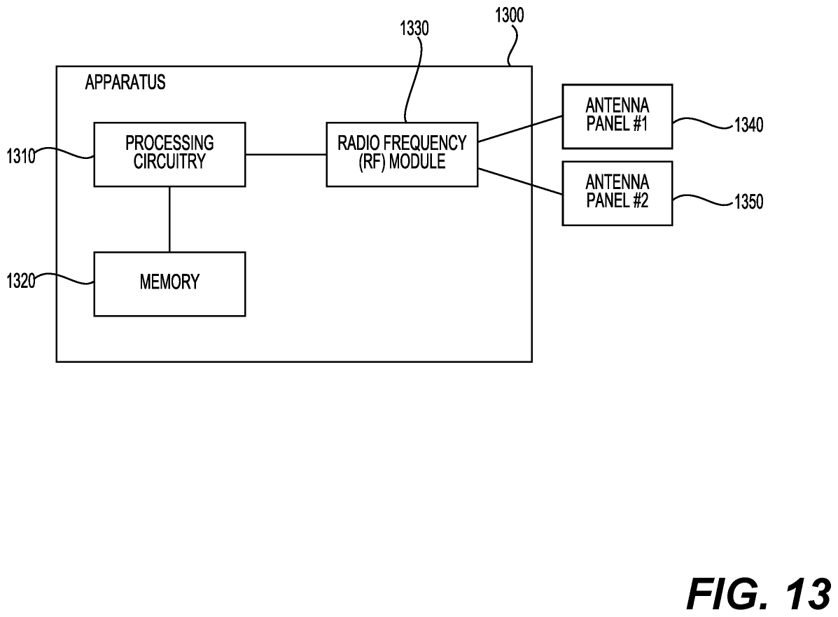

FIG. 13 shows an exemplary apparatus 1300 according to embodiments of the disclosure. The apparatus 1300 can be configured to perform various functions in accordance with one or more embodiments or examples described herein. Thus, the apparatus 1300 can provide means for implementation of techniques, processes, functions, components, systems described herein. For example, the apparatus 1300 can be used to implement functions of a UE or a base station (BS) (e.g., gNB) in various embodiments and examples described herein. The apparatus 1300 can include a general purpose processor or specially designed circuits to implement various functions, components, or processes described herein in various embodiments. The apparatus 1300 can include processing circuitry 1310, a memory 1320, and a radio frequency (RF) module 1330.

In various examples, the processing circuitry 1310 can include circuitry configured to perform the functions and processes described herein in combination with software or without software. In various examples, the processing circuitry 1310 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 1310 can be a central processing unit (CPU) configured to execute program instructions to perform various functions and processes described herein. Accordingly, the memory 1320 can be configured to store program instructions. The processing circuitry 1310, when executing the program instructions, can perform the functions and processes. The memory 1320 can further store other programs or data, such as operating systems, application programs, and the like. The memory 1320 can include a read only memory (ROM), a random access memory (RAM), a flash memory, a solid state memory, a hard disk drive, an optical disk drive, and the like.

The RF module 1330 receives a processed data signal from the processing circuitry 1310 and converts the data signal to beamforming wireless signals that are then transmitted via antenna panels 1340 and/or 1350, or vice versa. The RF module 1330 can include a digital to analog convertor (DAC), an analog to digital converter (ADC), a frequency up convertor, a frequency down converter, filters and amplifiers for reception and transmission operations. The RF module 1330 can include multi-antenna circuitry for beamforming operations. For example, the multi-antenna circuitry can include an uplink spatial filter circuit, and a downlink spatial filter circuit for shifting analog signal phases or scaling analog signal amplitudes. Each of the antenna panels 40 and 10 can include one or more antenna arrays.

In an embodiment, part of all the antenna panels 1340/1350 and part or all functions of the RF module 1330 are implemented as one or more TRPs (transmission and reception points), and the remaining functions of the apparatus 1300 are implemented as a BS. Accordingly, the TRPs can be co-located with such a BS, or can be deployed away from the BS.

The apparatus 1300 can optionally include other components, such as input and output devices, additional or signal processing circuitry, and the like. Accordingly, the apparatus 1300 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, comprising:
receiving, at a first node from a first neighbor node in a mesh network, a first discovery request comprising a first request for a route to a destination node in the mesh network;
in response to a routing table of the first node containing at least one route to the destination node, sending, to the first neighbor node, a first discovery response message comprising first information of the at least one route; and
in response to the routing table not containing at least one route to the destination node, sending, to a second neighbor node, a second discovery request comprising a second request for a route to the destination node.

2. The method of claim 1, wherein the first node, the first neighbor node, and the second neighbor node each are one of a user equipment (UE) and a base station.

3. The method of claim 1, wherein the first node establishes connections to the first and second neighbors by one of a PC5 unicast link, a radio resource control (RRC) connection, and a PC5-RRC connection.

4. The method of claim 1, wherein the first and second discovery requests and the first discovery response message are messages of a PC5-S protocol.

5. The method of claim 1, wherein the first and second discovery requests and the first discovery response message are sent by one of unicast, broadcast, and groupcast.

6. The method of claim 1, wherein the first information of the at least one route comprises at least one of a hop count, a measure of route quality, and an enumeration of nodes along the route.

7. The method of claim 1, wherein the first discovery request contains a first sequence number, the second discovery request contains a second sequence number, the first discovery response message contains a third sequence number, and the third sequence number is the same as the first sequence number.

8. The method of claim 1, wherein the first discovery request contains a maximum hop count, and the second discovery request is not sent in response to a hop count of the first discovery response exceeding the maximum hop count.

9. The method of claim 1, further comprising:
transmitting, to a second node in the mesh network, a discovery announcement comprising information that the first node has a radio connection to a third node, the third node being a node of a cellular network.

10. The method of claim 9, wherein the discovery announcement further comprises information about a link quality of the radio connection to the third node.

11. The method of claim 1, further comprising:
receiving, from the second neighbor node in the mesh network, a second discovery response message comprising second information of at least one route to the destination node;
updating the routing table of the first node by adding the at least one route; and
transmitting, to the first neighbor node in the mesh network, a third discovery response message comprising third information of the at least one route.

12. The method of claim 11, wherein the first discovery request contains at least one criterion, the second discovery response message contains a plurality of routes, and the third discovery response message omits at least one route from the second discovery response message based on the at least one route failing to meet the at least one criterion.

13. The method of claim 12, wherein the at least one criterion comprises at least one of a maximum hop count and a minimum route quality threshold.

14. The method of claim 11, wherein the second discovery response message and third discovery responses message are messages of a PC5-S protocol.

15. The method of claim 11, wherein the second discovery response message and third discovery response message are sent by one of unicast, broadcast, and groupcast.

16. The method of claim 11, wherein the second discovery response contains a fourth sequence number, the third discovery response message contains a fifth sequence number, the fourth sequence number is the same as the second sequence number, and the fifth sequence number is the same as the first sequence number.

17. An apparatus, processing circuitry configured to:
receive, at a first node from a first neighbor node in a mesh network, a first discovery request comprising a first request for a route to a destination node in the mesh network;
in response to a routing table of the first node containing at least one route to the destination node, send, to the first neighbor node, a first discovery response message comprising first information of the at least one route; and
in response to the routing table not containing at least one route to the destination node, send, to a second neighbor node, a second discovery request comprising a second request for a route to the destination node.

18. The apparatus of claim 17, wherein the processing circuitry is further configured to:
receive, from the second neighbor node in the mesh network, a second discovery response message comprising second information of at least one route to the destination node;
update the routing table of the first node by adding the at least one route; and
transmit, to the first neighbor node in the mesh network, a third discovery response message comprising third information of the at least one route.

19. A non-transitory computer-readable medium storing instructions that, when executed by a processor, cause to the processor to perform:
receiving, at a first node from a first neighbor node in a mesh network, a first discovery request comprising a first request for a route to a destination node in the mesh network;
in response to a routing table of the first node containing at least one route to the destination node, sending, to the first neighbor node, a first discovery response message comprising first information of the at least one route; and
in response to the routing table not containing at least one route to the destination node, sending, to a second neighbor node, a second discovery request comprising a second request for a route to the destination node.

20. The non-transitory computer-readable medium of claim 19, wherein the processor further performs:
receiving, from the second neighbor node in the mesh network, a second discovery response message comprising second information of at least one route to the destination node;
updating the routing table of the first node by adding the at least one route; and
transmitting, to the first neighbor node in the mesh network, a third discovery response message comprising third information of the at least one route.
